(19) United States
(12) Patent Application Publication
(10) Pub. No.: US 2007/0201859 A1
(43) Pub. Date: Aug. 30, 2007

(54) Method and system for use of 3D sensors in an image capture device

(75) Inventor: Frederic Sarrat, Paris (FR)

Correspondence Address: The Law Office of Deepti Panchawagh-Jain;c/o PortfolioIP, P.O. Box 52050, Minneapolis, MN, 55402, US

(73) Assignee: Logitech Europe S.A., Romanel-sur-Morges (CH)

(21) Appl. No.: 11/361,826

(22) Filed: Feb. 24, 2006

(51) Int. Cl. G03B 41/00

(52) U.S. Cl. 396/322

(57) ABSTRACT

The present invention is a system and method for the use of a 3D sensor in an image capture device. In one embodiment, a single 3D sensor is used, and the depth information is interspersed within the information for the other two dimensions so as to not compromise the resolution of the two-dimensional image. In another embodiment, a 3D sensor is used along with a 2D sensor. In one embodiment, a mirror is used to split incoming light into two portions, one of which is directed at the 3D sensor, and the other at the 2D sensor. The 2D sensor is used to measure information in two dimensions, while the 3D sensor is used to measure the depth of various portions of the image. The information from the 2D sensor and the 3D sensor is then combined, either in the image capture device or in a host system.

### BACKGROUND OF THE INVENTION

1. Field of the Invention

This invention relates generally to digital cameras for capturing still images and video, and more particularly, to the use of 3D sensors in such cameras.

2. Description of the Related Art

Digital cameras are increasingly being used by consumers to capture both still image and video data. Webcams, digital cameras connected to host systems, are also becoming increasingly common. Further, other devices that include digital image capturing capabilities, such as camera-equipped cell-phones and Personal Digital Assistants (PDAs) are sweeping the marketplace.

Most digital image capture devices include a single sensor which is two-dimensional (2D). Such two dimensional sensors, as the name suggests, only measure values in two-dimensions (e.g., along the X axis and the Y axis in a Cartesian coordinate system). 2D sensors lack the ability to measure the third dimension (e.g., along the Z axis in a Cartesian coordinate system). Thus, not only is the image created two-dimensional, but also, the 2D sensors are unable to measure the distance from the sensor (depth), of different portions of the image being captured.

Several attempts have been made at overcoming these issues. One approach includes having two cameras with a 2D sensor in each. These two cameras can be used stereoscopically, with the image from one sensor reaching each eye of the user, and a 3D image can be created. However, in order to achieve this, the user will need to have some special equipment, similar to glasses used to watch 3D movies. Further, while a 3D image is created, depth information is still not directly obtained. As is discussed below, depth information is important in several applications.

For several applications, the inability to measure the depth of different portions of the image is severely limiting. For example, some applications such as background replacement algorithms create a different background for the same user. (For example, a user may be portrayed as sitting on the beach, rather than in his office.) In order to implement such an algorithm, it is essential to be able to differentiate between the background and the user. It is difficult and inaccurate to distinguish between a user of a webcam and the background (e.g., chair, wall, etc.) using a two dimensional sensor alone, especially when some of these are of the same color. For instance, the user's hair and the chair on which she is sitting may both be black.

Three dimensional (3D) sensors may be used to overcome the limitations discussed above. In addition, there are several other applications where the measurement of depth of various points in an image can be harnessed. However, 3D sensors have conventionally been very expensive, and thus use of such sensors in digital cameras has not been feasible. Due to new technologies, some more affordable 3D sensors have recently been developed. However, measurements relating to depth are much more intensive than information relating to the other two dimensions. Thus pixels used for storing information relating to the depth (that is information in the third dimension) are necessarily much larger than the pixels used for storing information in the other two dimensions (information relating to the 2D image of the user and his environment). Further, making the 2D pixels much larger to accommodate the 3D pixels is not desirable, since this will compromise the resolution of the 2D information. Improved resolution in such cases implies increased size and increased cost.

There is thus a need for a digital camera which can perceive distance to various points in an image, as well as capture image information at a comparatively high resolution in two-dimensions, at a relatively low cost.

### BRIEF SUMMARY OF THE INVENTION

The present invention is a system and method for using a 3D sensor in digital cameras.

In one embodiment, a 3D sensor alone is used to obtain information in all three dimensions. This is done by placing appropriate (e.g., red (R), green (G) or blue (B)) filters on the pixels which obtain data for two dimensions, while other appropriate filters (e.g., IR filters) are placed on pixels measuring data in the third dimension (i.e. depth).

In order to overcome the above-mentioned issues, in one embodiment information for the various dimensions is stored in pixels of varied sizes. In one embodiment, the depth information is interspersed amongst the information along the other two dimensions. In one embodiment, the depth information surrounds information along the other two dimensions. In one embodiment, the 3D pixel is fit into a grid along with the 2D pixels, where the size of a single 3D pixel is equal to the size of numerous 2D pixels. In one embodiment, the pixels for measuring depth are four times the size of the pixels for measuring the other two dimensions. In another embodiment, a separate section of the 3D sensor measures distance, while the rest of the 3D sensor measures information in the other two dimensions.

In another embodiment, a 3D sensor is used in conjunction with a 2D sensor. The 2D sensor is used to obtain information in two dimensions, while the 3D sensor is used to measure the depths of various portions of the image. Since the 2D information used and the depth information used are on different sensors, the issues discussed above do not arise.

In one embodiment, light captured by the camera is split into two beams, one of which is received by the 2D sensor, and the other is received by the 3D sensor. In one embodiment, light appropriate for the 3D sensor (e.g., IR light) is directed towards the 3D sensor, while light in the visible spectrum is directed towards the 2D sensor. Thus color information in two dimensions and depth information are stored separately. In one embodiment, the information from the two sensors is combined on the image capture device and then communicated to a host. In another embodiment, the information from the two sensors is transmitted to the host separately, and then combined by the host.

Measuring the depth of various points of the image using a 3D sensor provides direct information about the distance to various points in the image, such as the user's face, and the background. In one embodiment, such information is used for various applications. Examples of such applications include background replacement, image effects, enhanced automatic exposure/auto-focus, feature detection and tracking, authentication, user interface (UI) control, model-based compression, virtual reality, gaze correction, etc.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

The invention has other advantages and features which will be more readily apparent from the following detailed description of the invention and the appended claims, when taken in conjunction with the accompanying drawing, in which:

FIG. 1 is a block diagram of a possible usage scenario including an image capture device.

FIG. 2 is a block diagram of some components of an image capture device 100 in accordance with an embodiment of the present invention

FIG. 3A illustrates an arrangement of pixels in a conventional 2D sensor.

3B illustrates an embodiment for storing information for the third dimension along with information for the other two dimensions.

FIG. 3C illustrates another embodiment for storing information for the third dimension along with information for the other two dimensions.

FIG. 4 a block diagram of some components of an image capture device in accordance with an embodiment of the present invention.

FIG. 5 is a flowchart which illustrates the functioning of a system in accordance with an embodiment of the present invention.

### DETAILED DESCRIPTION OF INVENTION

The figures depict a preferred embodiment of the present invention for purposes of illustration only. It is noted that similar or like reference numbers in the figures may indicate similar or like functionality. One of skill in the art will readily recognize from the following discussion that alternative embodiments of the structures and methods disclosed herein may be employed without departing from the principles of the invention(s) herein. It is to be noted that the examples that follow focus on webcams, but that embodiments of the present invention could be applied to other image capturing devices as well.

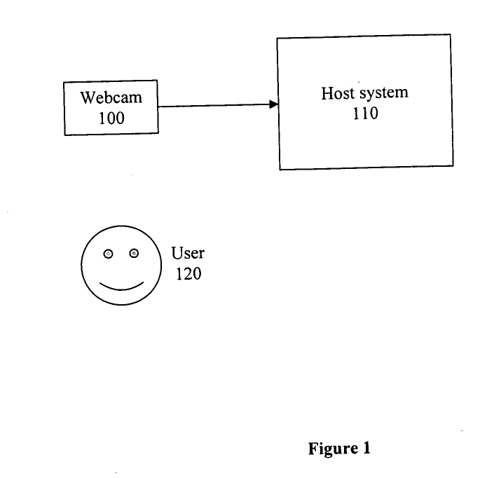

FIG. 1 is a block diagram illustrating a possible usage scenario with an image capture device 100, a host system 110, and a user 120.

In one embodiment, the data captured by the image capture device 100 is still image data. In another embodiment, the data captured by the image capture device 100 is video data (accompanied in some cases by audio data). In yet another embodiment, the image capture device 100 captures either still image data or video data depending on the selection made by the user 120. In one embodiment, the image capture device 100 is a webcam. Such a device can be, for example, a QuickCam® from Logitech, Inc. (Fremont, Calif.). It is to be noted that in different embodiments, the image capture device 100 is any device that can capture images, including digital cameras, digital camcorders, Personal Digital Assistants (PDAs), cell-phones that are equipped with cameras, etc. In some of these embodiments, host system 110 may not be needed. For instance, a cell phone could communicate directly with a remote site over a network. As another example, a digital camera could itself store the image data.

Referring back to the specific embodiment shown in FIG. 1, the host system 110 is a conventional computer system, that may include a computer, a storage device, a network services connection, and conventional input/output devices such as, a display, a mouse, a printer, and/or a keyboard, that may couple to a computer system. The computer also includes a conventional operating system, an input/output device, and network services software. In addition, in some embodiments, the computer includes Instant Messaging (IM) software for communicating with an IM service. The network service connection includes those hardware and software components that allow for connecting to a conventional network service. For example, the network service connection may include a connection to a telecommunications line (e.g., a dial-up, digital subscriber line (“DSL”), a T1, or a T3 communication line). The host computer, the storage device, and the network services connection, may be available from, for example, IBM Corporation (Armonk, N.Y.), Sun Microsystems, Inc. (Palo Alto, Calif.), or Hewlett-Packard, Inc. (Palo Alto, Calif.). It is to be noted that the host system 110 could be any other type of host system such as a PDA, a cell-phone, a gaming console, or any other device with appropriate processing power.

It is to be noted that in one embodiment, the image capture device 100 is integrated into the host 110. An example of such an embodiment is a webcam integrated into a laptop computer.

The image capture device 100 captures the image of a user 120 along with a portion of the environment surrounding the user 120. In one embodiment, the captured data is sent to the host system 110 for further processing, storage, and/or sending on to other users via a network.

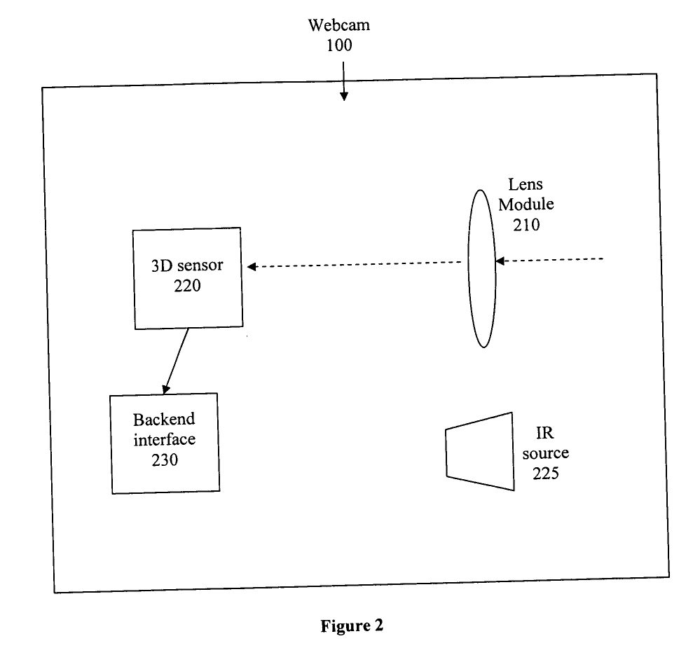

FIG. 2 is a block diagram of some components of an image capture device 100 in accordance with an embodiment of the present invention. The image capture device 100 includes a lens module 210, a 3D sensor 220, and an Infra-Red (IR) light source 225.

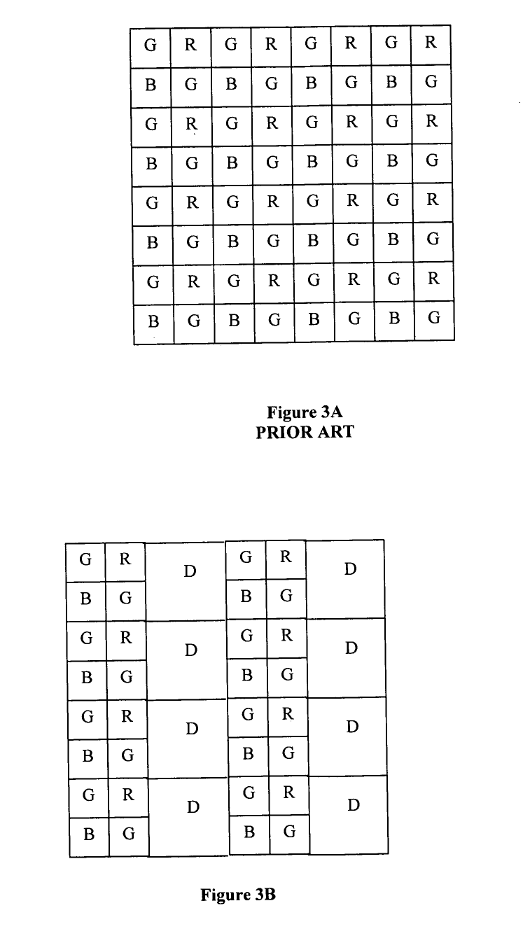

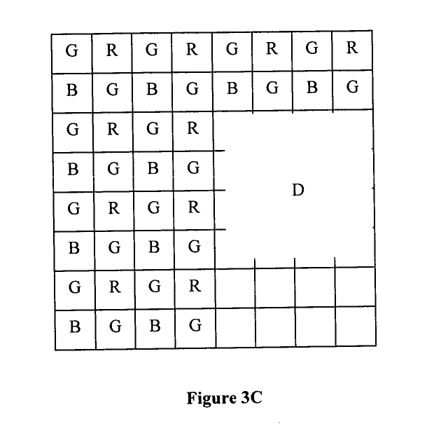

The lens module 210 can be any lens known in the art. The 3D sensor is a sensor that can measure information in all three dimensions (e.g., the X, Y and Z axis in a Cartesian coordinate system). In this embodiment, the 3D sensor 220 measures depth by using IR light, which is provided by the IR light source 225. The IR light source 225 is discussed in more detail below. The 3D sensor measures information for all three dimensions, and this is discussed further with respect to FIGS. 3B and 3C.

The backend interface 230 interfaces with the host system 110. In one embodiment, the backend interface is a USB interface.

FIGS. 3A-3C depict various pixel grids in a sensor. FIG. 3A illustrates a conventional two-dimensional grid for a 2D sensor, where color information in only two dimensions is being captured. (Such an arrangement is called a Bayer pattern). The pixels in such a sensor are all of uniform dimension, and have green (G), blue (B), and red (R) filters on the pixels to measure color information in two dimensions.

As mentioned above, the pixels measuring distance need to be significantly larger (e.g., about 40 microns) as compared to the pixels measuring information in the other two dimensions (e.g. less than about 5 microns).

FIG. 3B illustrates an embodiment for storing information for the third dimension along with information for the other two dimensions. In one embodiment, the pixel for measuring distance (D) is covered by an IR filter, and is as large as several pixels for storing information along the other two dimensions (R, G, B). In one embodiment, the size of the D pixel is four times the size of the R, G, B pixels, and the D pixel is interwoven with the R, G, B pixels as illustrated in FIG. 3B. The D pixels use light emitted from the IR source 225, which is reflected by the image being captured, while the R, G, B pixels use visible light.

FIG. 3C illustrates another embodiment for storing information for the third dimension along with information for the other two dimensions. As can be seen from FIG. 3C, in one embodiment, the D pixels are placed in a different location on the sensor as compared to the R, G, B pixels.

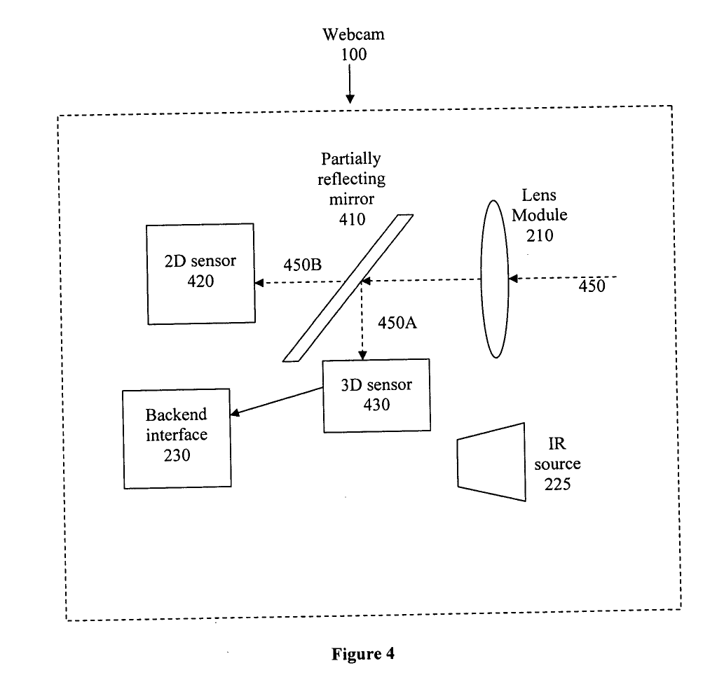

FIG. 4 is a block diagram of some components of an image capture device 100 in accordance with an embodiment of the present invention, where a 3D sensor 430 is used along with a 2D sensor 420. A lens module 210 and a partially reflecting mirror 410 are also shown, along with the IR source 225 and the backend interface 230.

In this embodiment, because the two dimensional information used is stored separately from the depth information used, the issues related to the size of the depth pixel do not arise.

In one embodiment, the 3D 430 sensor uses IR light to measure the distance to various points in the image being captured. Thus, for such 3D sensors 430, an IR light source 225 is needed. In one embodiment, the light source 225 is comprised of one or more Light Emitting Diodes (LEDs). In on embodiment, the light source 225 is comprised of one or more laser diodes.

It is important to manage dissipation of the heat generated by the IR source 225. Power dissipation considerations may impact the materials used for the case of the image capture device 100. In some embodiments, a fan may need to included to assist with heat dissipation. If not dissipated properly, the heat generated will affect the dark current in the sensor 220, thus reducing the depth resolution. The lifetime of the light source can also be affected by the heat.

The light reflected from the image being captured will include IR light (generated by the IR source 225), as well as regular light (either present in the environment, or by a regular light source such as a light flash, which is not shown). This light is depicted by arrow 450. This light passes through the lens module 210 and then hits the partially reflecting mirror 410, and is split by it into 450A and 450B.

In one embodiment, the partially reflecting mirror 410 splits the light into 450A, which has IR wavelengths which are conveyed to the 3D sensor 430, and 450B, which has visible wavelengths which are conveyed to the 2D sensor 420. In one embodiment, this can be done using a hot or cold mirror, which will separate the light at a cut-off frequency corresponding to the IR filtering needed for the 3D sensor 430. It is to be noted that the incoming light can be split in ways other than by use of a partially reflecting mirror 410.

In the embodiment depicted in FIG. 4, it can be seen that the partially reflecting mirror 410 is placed at an angle from the incoming light beam 450. The angle of the partially reflecting mirror 410 with respect to the incoming light beam 450 determines the directions in which the light will be split. The 3D sensor 430 and the 2D sensor 420 are placed appropriately to receive the light beams 450A and 450B respectively. The angle at which the mirror 410 is placed with respect to the incoming light 450 affects the ratio of light reflected to light transmitted. In one embodiment, the mirror 410 is angled at 45 degrees with respect to the incoming light 450.

In one embodiment, the 3D sensor 430 has an IR filter on it so that it receives only the appropriate component of the IR light 450A. In one embodiment, as described above, the light 450B reaching the 3D sensor 430 only has IR wavelengths. In addition, however, in one embodiment the 3D sensor 430 still needs to have a band-pass filter, to remove the infra-red wavelengths other than the IR source's 225 own wavelength. In other words, the band-pass filter on the 3D sensor 220 is matched to allow only the spectrum generated by the IR source 225 to pass through. Similarly, the pixels in the 2D sensor 420 have R, G, and B filters on them as appropriate. Examples of 2D sensors 420 include CMOS sensors such as those from Micron Technology, Inc. (Boise, Id.), STMicroelectronics (Switzerland), and CCD sensors such as those from Sony Corp. (Japan), and Sharp Corporation (Japan). Examples of 3D sensors 430 include those provided by PMD Technologies (PMDTec) (Germany), Centre Suisse d'Electronique et de Microtechnique (CSEM) (Switzerland), and Canesta (Sunnyvale, Calif.).

Because the 2D and 3D sensors are distinct in this case, the incompatibility in the sizes of pixels storing 2D information and 3D information does not need to be addressed in this embodiment.

The data obtained from the 2D sensor 420 and the 3D sensor 430 needs to be combined. This combination of the data can occur in the image capture device 100 or in the host system 110. An appropriate backend interface 230 will be needed if the data from the two sensors is to be communicated to the host 110 separately. A backend interface 230 which allows streaming data from two sensors to the host system 110 can be used in one embodiment. In another embodiment, two backends (e.g. USB cables) are used to do this.

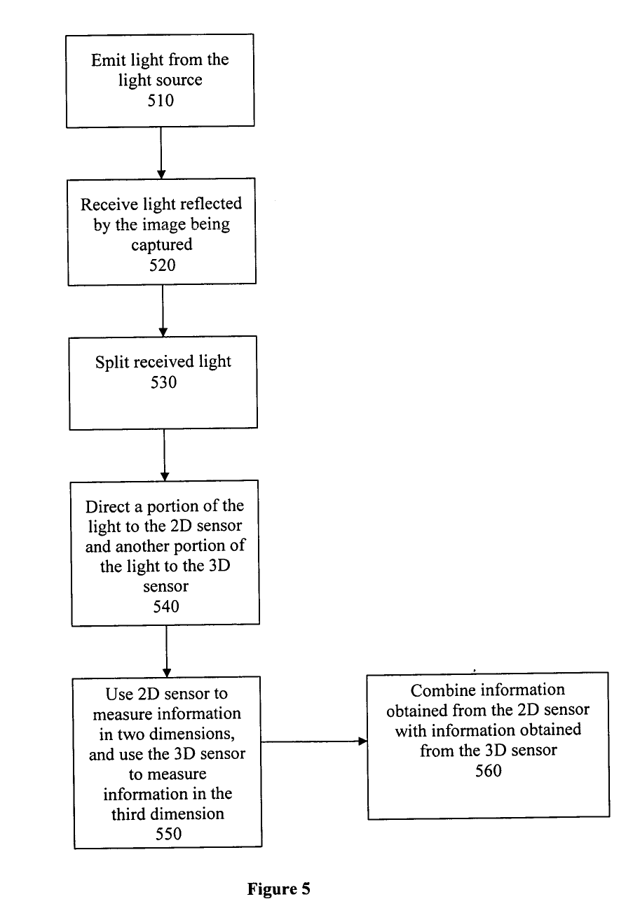

FIG. 5 is a flowchart which illustrates how an apparatus in accordance with the embodiment illustrated in FIG. 4 functions. Light is emitted (step 510) by the IR light source 225. The light that is reflected by the image being captured is received (step 520) by the image capture device 100 through its lens module 210. The light received is then split (step 530) by mirror 410 into two portions. One portion is directed (step 540) towards the 2D sensor 420 and another portion is directed to the 3D sensor 430. In one embodiment, the light directed towards the 2D sensor 420 is visible light, while the light directed towards the 3D sensor 430 is IR light. The 2D sensor 420 is used to measure (550) color information in two dimensions, while the 3D sensor 430 is used to measure depth information (that is, information in the third dimension). The information from the 2D sensor 420 and the information from the 3D sensor 430 is combined (step 560). As discussed above, in one embodiment, this combination is done within the image capture device 100. In another embodiment, this combination is done in the host system 110.

Measuring depth to various points of the image using a 3D sensor provides direct information about the distance to various points in the image, such as the user's face, and the background. In one embodiment, such information is used for various applications. Examples of such applications include background replacement, image effects, enhanced automatic exposure/auto-focus, feature detection and tracking, authentication, user interface (UI) control, model-based compression, virtual reality, gaze correction, etc. Some of these are discussed in further detail below.

Several effects desirable in video communications such as background replacement, 3D avatars, model-based compression, 3D display, etc. can be provided by an apparatus in accordance with present invention. In such video communications, the user 120 often uses a webcam 100 connected to a personal computer (PC) 110. Typically, the user 120 sits behind the PC 110 at a maximum distance of 2 meters.

An effective way for implementing an effect such as background replacement presents many challenges. The main issue is to discriminate between user 120 and close objects like table, or back of the chair (unfortunately often dark). Further complications are created because parts of the user 120 (e.g., the user's hair) are very similar in color to objects in the background (e.g., the back of the user's chair). Thus a difference in the depth of different portions of the image can be an elegant way of resolving these issues. For instance, the back of the chair is generally further away fro the camera than the user 120 is. In one embodiment, in order to be effective, precision of no more than 2 cm (for example, to discriminate between user and the chair behind).

Other applications such as 3D avatars and model-based compression require even more precision if implemented based on depth detection alone. However, in one embodiment, the depth information obtained can be combined with other information obtained. For example, there are several algorithms known in the art for detecting and/or tracking a user's 120 face using the 2D sensor 420. Such face detection etc. can be combined with the depth information in various applications.

Yet another application of the embodiments of the present invention is in the field of gaming (e.g., for object tracking). In such an environment, the user 120 sits or stands behind the PC or gaming console 110 at a distance of up to 5 m. Objects to be tracked can be either the user itself, or objects that the user would manipulate (e.g., a sword, etc.). Also, depth resolution requirements are less stringent (probably around 5 cm).

Still another application of the embodiments of the present inventions is in user-interaction (e.g., authentication or gesture recognition). Depth information makes it easier to implement face recognition. Also, unlike a 2D image which could not recognize the same person from two different angles, a 3D system would be able, by taking a single snapshot, to recognize the person, even when the user's head is sideways (as seen from the camera).

While particular embodiments and applications of the present invention have been illustrated and described, it is to be understood that the invention is not limited to the precise construction and components disclosed herein and that various modifications, changes, and variations which will be apparent to those skilled in the art may be made in the arrangement, operation and details of the method and apparatus of the present invention disclosed herein, without departing from the spirit and scope of the invention as defined in the following claims. For example, if a 3D sensor worked without IR light, the IR light source and/or IR filters would not be needed. As another example, the 2D information being captured could be in black and white rather than in color. As still another example, two sensors could be used, both of which capture information in two dimensions. As yet another example, the depth information obtained can be used alone, or in conjunction with the 2D information obtained, in various other applications.

What is claimed is:

1. An image capturing device comprising:
a first sensor to capture information in two dimensions;
a second sensor to capture information in a third dimension;
and a splitter to split incoming light so as to direct a first portion of the incoming light to the first sensor and a second portion of the incoming light to the second sensor.

2. The image capturing device of claim 1, further comprising:
a lens module for focusing the incoming light.

3. The image capturing device of claim 1, wherein the splitter is a mirror placed at an angle with respect to the incoming light.

4. The image capturing device of claim 3, wherein the mirror is a hot mirror.

5. The image capturing device of claim 3, wherein the mirror is a cold mirror.

6. The image capturing device of claim 1, further comprising:
an Infra-Red light source.

7. The image capturing device of claim 6, wherein the second sensor utilizes Infra-Red light generated by the Infra-Red light source.

8. The image capturing device of claim 7, wherein the first portion of the incoming light is comprised of visible wavelengths of light, and the second portion of the incoming light is comprised of Infra-Red wavelengths of light.

9. The image capturing device of claim 7, wherein the second sensor is covered with a band-pass filter which allows to pass through Infra-Red light corresponding to the Infra-Red light generated by the Infra-Red light source.

10. A method of capturing an image, comprising:
receiving light reflected from an image;
splitting the received light into a first portion and a second portion;
directing the first portion to a first sensor for capturing the image; and
directing the second portion to a second sensor for capturing the image.

11. The method of claim 10, further comprising:
combining information captured by the first sensor with the information captured with the second sensor.

12. The method of claim 10, wherein the step of receiving light comprises:
focusing the light reflected from an image using a lens module.

13. An optical system for capturing images, comprising:
a lens to focus incoming light; and
a mirror to receive the focused incoming light and to split the light into a plurality of components.

14. The optical system of claim 13, further comprising:
a first sensor to receive a first of the plurality of components of the light; and
a second sensor to receive a second of the plurality of components of the light.

15. A method of manufacture of an image capturing device, comprising:
inserting a first sensor to capture information in two dimensions;
inserting a second sensor to capture information in a third dimension; and
inserting a mirror at an angle split incoming light, so that the mirror can direct a first portion of incoming light to the first sensor and a second portion of the incoming light to the second sensor.

13. The method of manufacture of claim 15, further comprising:
inserting a light source emitting light at wavelengths used by the second sensor.

17. The method of manufacture of claim 15, further comprising:
inserting a lens module for receiving the incoming light and directing it to the mirror.

18. The method of manufacture of claim 15, wherein the mirror is a hot mirror.

19. The method of manufacture of claim 15, wherein the mirror is a cold mirror.
